(19) United States
(12) Patent Application Publication
(10) Pub. No.: US 2026/0177853 A1
(43) Pub. Date: Jun. 25, 2026

(54) DISPLAY DEVICE

(71) Applicant: Shanghai Tianma Micro-Electronics Co., Ltd., Shanghai (CN)

(72) Inventors: Hitoshi YOSHIDA, Kawasaki (JP); Futoshi NAKANISHI, Kawasaki (JP); Noriyuki ITOU, Kawasaki (JP); Akira BANJOUYA, Kawasaki (JP); Akira SUZUKI, Kawasaki (JP); Koetsu ISHIKAWA, Kawasaki (JP); Yoko TAKAMADATE, Kawasaki (JP)

(73) Assignee: Shanghai Tianma Micro-Electronics Co., Ltd., Shanghai (CN)

(21) Appl. No.: 19/404,388

(22) Filed: Dec. 1, 2025

(30) Foreign Application Priority Data
Dec. 24, 2024 (JP) 2024-227520
Sep. 16, 2025 (JP) 2025-152993

(51) Int. Cl. G02F 1/1335

(52) U.S. Cl. CPC G02F 1/133504

(57) ABSTRACT

A display device includes: a display panel; an internal diffusion layer that is adhered to a display surface of the display panel and diffuses display light emitted from the display panel inside the internal diffusion layer; and a decorative member that is adhered to the internal diffusion layer, and transmits the display light emitted from the display panel and provides an observer with a design.

### CROSS-REFERENCE TO RELATED APPLICATIONS

This application claims the benefit of Japanese Patent Application No. 2024-227520, filed on Dec. 24, 2024, and Japanese Patent Application No. 2025-152993 filed on Sep. 16, 2025, of which the entirety of the disclosures is incorporated by reference herein.

### FIELD OF THE INVENTION

This application relates generally to a display device.

### BACKGROUND OF THE INVENTION

In the related art, display devices are known in which a light-transmitting decorative member is disposed on a display surface side of a display panel to improve design. For example, Japanese U.S. Pat. No. 7,054,475 discloses an electronic device including a display device with pixels and a stacked body. The stacked body includes a pattern layer that has a pattern portion that shapes a pattern and a transparent portion that is a portion where the pattern portion is not shaped and a diffusion sheet that is arranged between the pattern layer and the display device and includes a surface diffusion layer. The surface diffusion layer of the diffusion sheet is disposed on the opposite side to the side in close contact with the pattern layer of the diffusion sheet, and the stacked body is arranged in such a way that the side on which the diffusion sheet is disposed faces the display device.

In the electronic device described in Japanese U.S. Pat. No. 7,054,475, the surface diffusion layer of the diffusion sheet diffuses light emitted from the display device. This configuration suppresses moiré that occurs caused by an arrangement of the transparent portion and an arrangement of the pixels.

On the other hand, in a display device including a display panel and a decorative member without including a diffusion layer, sparkles (bright spots) sometimes occur by display light from the display panel that is emitted through ink shaping the decorative member.

When the diffusion sheet including the surface diffusion layer described in Japanese U.S. Pat. No. 7,054,475 is applied to a display device that includes a display panel and a decorative member and in which sparkles occur, since display light emitted from the display panel is reflected at an interface between the surface diffusion layer and an air layer, quality of an image displayed on the display device is likely to deteriorate. In addition, preferable thickness of the diffusion sheet is specified to be 450 μm or more in Japanese U.S. Pat. No. 7,054,475, and the thickness of the diffusion sheet is thick.

### SUMMARY OF THE INVENTION

A display device of the present disclosure includes:
a display panel;
an internal diffusion layer that is adhered to a display surface of the display panel and diffuses display light emitted from the display panel inside the internal diffusion layer; and
a decorative member that is adhered to the internal diffusion layer, and transmits the display light emitted from the display panel and provides an observer with a design.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a side view illustrating a display device according to Embodiment 1;

FIG. 2 is a plan view illustrating a liquid crystal display panel according to Embodiment 1;

FIG. 3 is a cross-sectional view illustrating the liquid crystal display panel according to Embodiment 1;

FIG. 4 is a cross-sectional view illustrating an internal diffusion layer according to Embodiment 1;

FIG. 5 is a schematic diagram illustrating thicknesses and distances according to Embodiment 1;

FIG. 6 is a diagram illustrating haze values of the internal diffusion layer and presence or absence of sparkles according to Embodiment 1;

FIG. 7 is a side view illustrating an internal diffusion layer and a decorative member according to Embodiment 2;

FIG. 8 is a cross-sectional view illustrating the internal diffusion layer according to Embodiment 2;

FIG. 9 is a side view illustrating an internal diffusion layer and a decorative member according to Embodiment 3;

FIG. 10 is a side view illustrating a display device according to a variation;

FIG. 11 is a side view illustrating a display device according to another variation;

FIG. 12 is a diagram illustrating patterns and transmittances of decorative members and presence or absence of sparkles according to Example 1;

FIG. 13 is a diagram illustrating pixel pitches of liquid crystal display panels, haze values of internal diffusion layers, and presence or absence of sparkles according to Example 2; and

FIG. 14 is a diagram illustrating relationships between a haze value of an internal diffusion layer and perpendicular distance between a display surface of a liquid crystal display panel and a central line of the internal diffusion layer according to Embodiments 3 and 4.

### DETAILED DESCRIPTION OF THE INVENTION

Display devices according to embodiments are described below with reference to the drawings.

### Embodiment 1

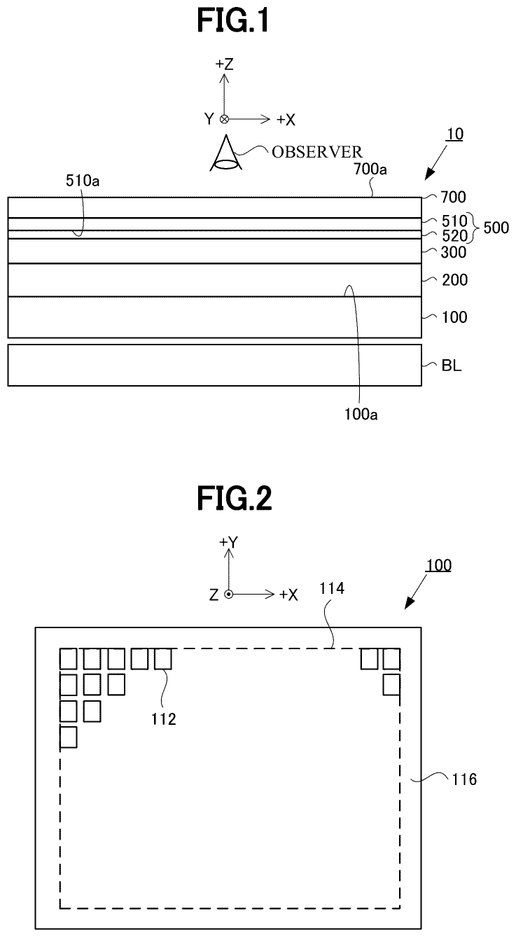

With reference to FIGS. 1 to 6, a display device 10 according to the present embodiment is described. The display device 10 includes, as illustrated in FIG. 1, a liquid crystal display panel 100, an internal diffusion layer 300, a decorative member 500, and a cover 700. Further, the display device 10 includes a backlight BL and an adhesive layer 200. The liquid crystal display panel 100 displays characters, an image, or the like. The internal diffusion layer 300 transmits, while diffusing, display light emitted from the liquid crystal display panel 100. The decorative member 500 transmits the display light emitted from the liquid crystal display panel 100 that has passed through the internal diffusion layer 300 and displays an image displayed on the liquid crystal display panel 100 in a see-through manner. The cover 700 protects the liquid crystal display panel 100. The adhesive layer 200 adheres the liquid crystal display panel 100 and the internal diffusion layer 300 to each other. The backlight BL is a light source for the liquid crystal display panel 100.

The display device 10 is installed on a dashboard of a car, furniture, a home appliance, or the like. Note that, herein, to facilitate understanding, description is made assuming that, in FIG. 1, the right longitudinal direction of the display device 10 (the rightward direction of the plane of paper) is a +X-direction, the upward direction of the display device 10 (the upward direction of the plane of paper) is a +Z-direction, and a direction orthogonal to the +X-direction and the +Z-direction (the depth direction of the plane of paper) is a +Y-direction. A user is located on the +Z side of the display device 10.

The liquid crystal display panel 100 of the display device 10 is, for example, a transmission-type liquid crystal display panel of an in-plane switching system, driven by an active matrix of thin film transistors (TFT). The liquid crystal display panel 100 includes, as illustrated in FIG. 2, a displayable area 114 where pixels 112 are arranged in a matrix and a bezel area 116 that surrounds the displayable area 114 and where wiring, a driver circuit, and the like are disposed. The displayable area 114 is an area where characters, an image, or the like can be displayed, while the bezel area 116 is an area where characters, an image, and the like cannot be displayed.

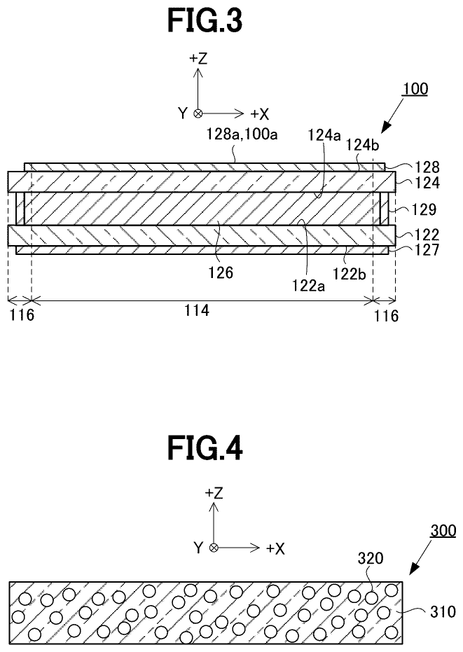

The liquid crystal display panel 100 includes, as illustrated in FIG. 3, a TFT substrate 122, a counter substrate 124, a liquid crystal 126, a first polarizing plate 127, and a second polarizing plate 128. The TFT substrate 122 and the counter substrate 124 sandwich the liquid crystal 126. The first polarizing plate 127 is disposed on the TFT substrate 122, and the second polarizing plate 128 is disposed on the counter substrate 124.

The TFT substrate 122 is, for example, a glass substrate. TFT substrate 122 is located on the −Z side. On a main surface 122a on the liquid crystal 126 side of the TFT substrate 122, TFTs for selecting pixels, gate wiring, data wiring, a common electrode, pixel electrodes, an alignment film for aligning the liquid crystal 126, and the like are disposed (all of the foregoing are not illustrated). On a main surface 122b on an opposite side to the main surface 122a of the TFT substrate 122, the first polarizing plate 127 is disposed.

The counter substrate 124 is located on the +Z side and faces the TFT substrate 122. The counter substrate 124 is adhered to the TFT substrate 122 by sealing material 129. The counter substrate 124 is, for example, a glass substrate. On the main surface 124a on the liquid crystal 126 side of the counter substrate 124, a color filter, a black matrix, an alignment film for aligning the liquid crystal 126, and the like are disposed (all of the foregoing are not illustrated). On a main surface 124b on the opposite side to the main surface 124a of the counter substrate 124, the second polarizing plate 128 is disposed.

The liquid crystal 126 is sandwiched between the TFT substrate 122 and the counter substrate 124. The liquid crystal 126 is, for example, a positive nematic liquid crystal. The liquid crystal 126 is initially aligned in a direction parallel with the main surface 122a of the TFT substrate 122 by the alignment film. In addition, the liquid crystal 126 rotates in a plane parallel with the main surface 122a of TFT substrate 122 when a voltage is applied.

The first polarizing plate 127 is disposed on the main surface 122b of the TFT substrate 122, and the second polarizing plate 128 is disposed on the main surface 124b of the counter substrate 124. One transmission axis of a transmission axis of the first polarizing plate 127 and a transmission axis of the second polarizing plate 128 is arranged parallel with the initial alignment direction of the liquid crystal 126, and the transmission axis of the first polarizing plate 127 and the transmission axis of the second polarizing plate 128 are orthogonal to each other. In the present embodiment, a main surface 128a on the +Z side of the second polarizing plate 128 corresponds to a display surface 100a of the liquid crystal display panel 100.

The backlight BL of the display device 10 is arranged, as illustrated in FIG. 1, on a back surface side of the liquid crystal display panel 100. The backlight BL is, for example, a direct type backlight. The backlight BL includes a white light emitting diode (LED) element, a reflection sheet, a diffusion sheet, a lighting circuit, and the like (all of the forgoing are not illustrated).

The adhesive layer 200 of the display device 10 has translucency and adheres the display surface 100a of the liquid crystal display panel 100 and the internal diffusion layer 300 to each other. The adhesive layer 200 is made of, for example, optical clear adhesive (OCA).

The internal diffusion layer 300 of the display device 10 is arranged on (on the +Z side of) the display surface 100a of the liquid crystal display panel 100 and transmits, while diffusing, display light emitted from the liquid crystal display panel 100. The internal diffusion layer 300 is adhered to the display surface 100a of the liquid crystal display panel 100 by the adhesive layer 200 and diffuses display light emitted from the liquid crystal display panel 100 inside the internal diffusion layer 300. That is, diffusion of the display light by the internal diffusion layer 300 does not require an air layer between the internal diffusion layer 300 and the display surface 100a. Therefore, unnecessary reflection of display light can be suppressed, and deterioration in image quality of characters, an image, or the like displayed on the display device 10 can be thereby suppressed.

The internal diffusion layer 300 includes, as illustrated in FIG. 4, a binder 310 and fine particles 320 dispersed in the binder 310. The binder 310 has translucency. The binder 310 is made of, for example, acrylic resin. In the present embodiment, the binder 310 is made of OCA, and the internal diffusion layer 300 and the decorative member 500 are adhered to each other by the binder 310.

The fine particles 320 in the internal diffusion layer 300 are made of a styrene polymer, an acrylate polymer, or the like. An average grain size of the fine particles 320 is, for example, several nanometers to several hundred nanometers. The average grain size is measured by a dynamic light scattering method. The average grain size may be measured by a small angle X-ray scattering, a laser diffraction method, microscope observation, or the like.

Thickness of the internal diffusion layer 300 is preferably 50 μm or more. Since when a haze value H of the internal diffusion layer 300 is too large, a display on the display device 10 becomes blurred, the haze value H of the internal diffusion layer 300 is preferably 95% or less. In addition, as described later, the haze value H of the internal diffusion layer 300 is preferably 5% more.

Returning to FIG. 1, the decorative member 500 of the display device 10 is a member that gives the display device 10 a design, and the decorative member 500 provides the observer with the design. The decorative member 500 has translucency and displays an image displayed on the liquid crystal display panel 100 in a see-through manner. The decorative member 500 is arranged on (on the +Z side of) the internal diffusion layer 300 and is adhered to the internal diffusion layer 300. As described later, a transmittance of the decorative member 500 for display light emitted from the liquid crystal display panel 100 is preferably 20% or more.

The decorative member 500 include a base member 510 that have translucency and a decorative layer 520. The base member 510 of the decorative member 500 supports the decorative layer 520. The base member 510 is, for example, a translucent film that is made of a synthetic resin. The decorative layer 520 of the decorative member 500 is a layer that gives the display device 10 a design and provides the observer with the design. The decorative layer 520 is formed on a main surface 510a on the liquid crystal display panel 100 side of the base member 510. The decorative layer 520 is, for example, made by printing, with pigment ink, an arbitrary color pattern, such as wood grain, marble tone, and a geometric pattern, an arbitrary color, and the like. The pigment ink is made of a binder and pigment.

The cover 700 of the display device 10 has translucency and protects the liquid crystal display panel 100. The cover 700 is arranged on (on the +Z side of) the decorative member 500, and is adhered to the base member 510 of the decorative member 500 by a not-illustrated translucent adhesive. The cover 700 is a glass substrate, a plastic substrate, or the like. The main surface 700a on the user side (+Z side) of the cover 700 is preferably subjected to low reflection treatment. Hereinbelow, the main surface 700a of the cover 700 is assumed to be subjected to the low reflection treatment.

Occurrence of sparkles (bright spots) and advantageous effects of the present embodiment are described below. In the following description, when the display device 10 is viewed in cross section, thickness of the adhesive layer 200, thickness of the internal diffusion layer 300, and thickness of the decorative layer 520 are denoted by D1, D2, and D3, respectively, as illustrated by FIG. 5. In addition, perpendicular distance between the display surface 100a of the liquid crystal display panel 100 and a central line C1 in the thickness direction of the decorative layer 520, perpendicular distance between a central line C2 in the thickness direction of the internal diffusion layer 300 and the central line C1 in the thickness direction of the decorative layer 520, and perpendicular distance between the display surface 100a of the liquid crystal display panel 100 and the central line C2 in the thickness direction of the internal diffusion layer 300 are denoted by L1, L2, and L3, respectively.

In a display device not including the internal diffusion layer 300 (hereinafter referred to as a display device of Comparative Example 1), when display light emitted from the liquid crystal display panel 100 is transmitted through the decorative layer 520 of the decorative member 500, it is supposed that the binder, filling a space between pigments in the pigment ink included in the decorative layer 520, acts like a lens or prism on the display light emitted from the liquid crystal display panel 100. As a result, intensity of the display light transmitted through the decorative layer 520 varies, and a part where the intensity of the display light is high is recognized as a sparkle by the user. Note that a configuration of the display device of the Comparative Example 1 is the same as the configuration of the display device 10 with the exception of not including the internal diffusion layer 300.

In the present embodiment, the internal diffusion layer 300 is arranged over the display surface 100a of the liquid crystal display panel 100 via the adhesive layer 200, and the decorative member 500 (decorative layer 520) is arranged on the internal diffusion layer 300. Therefore, before display light emitted from the liquid crystal display panel 100 is transmitted through the decorative layer 520, the display light emitted from the liquid crystal display panel 100 is diffused by the internal diffusion layer 300. As a result, since the strength and weakness of the display light transmitted through the decorative layer 520 is suppressed, occurrence of sparkles is supposed to be able to be suppressed.

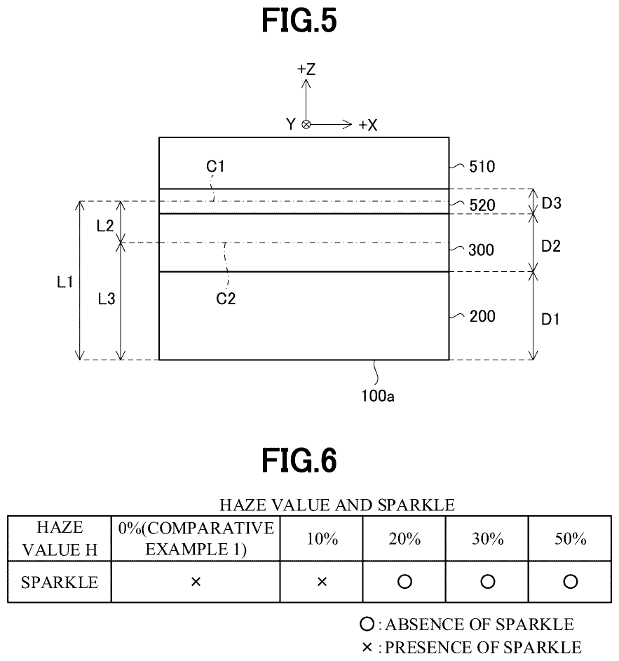

For example, when the design of the decorative member 500 is set to a wood-grain pattern (a transmittance of 50%, dark brown), the thickness D1 of the adhesive layer 200, the thickness D2 of the internal diffusion layer 300, the thickness D3 of the decorative layer 520 are set to 905 μm, 50 μm, and 30 μm, respectively, and the haze value H of the internal diffusion layer 300 is varied, setting the haze value H of the internal diffusion layer 300 to 20% or more enables to be suppressed the occurrence of sparkles in the display device 10, as illustrated in FIG. 6. Note that a pixel pitch of the liquid crystal display panel 100 is 129.5 μm. In addition, the perpendicular distance L1 between the display surface 100a of the liquid crystal display panel 100 and the central line C1 in the thickness direction of the decorative layer 520, the perpendicular distance L2 between the central line C2 in the thickness direction of the internal diffusion layer 300 and the central line C1 in the thickness direction of the decorative layer 520, and the perpendicular distance L3 between the display surface 100a of the liquid crystal display panel 100 and the central line C2 in the thickness direction of the internal diffusion layer 300 are 970 μm, 40 μm, and 930 μm, respectively.

Evaluation of presence or absence of sparkles in FIG. 6 is based on subjective evaluation performed by a plurality of persons. In the following description, the evaluation of presence or absence of sparkles is also based on subjective evaluation performed by a plurality of persons.

As described above, arranging the internal diffusion layer 300 between the display surface 100a of the liquid crystal display panel 100 and the decorative member 500 and adhering the internal diffusion layer 300 to the display surface 100a of the liquid crystal display panel 100 and the decorative member 500 enable to be suppressed the occurrence of sparkles. In addition, deterioration in quality of characters, an image, and the like displayed on the display device 10 can be suppressed. Further, the internal diffusion layer 300 can be made thin.

### Embodiment 2

In Embodiment 1, the haze value H of the internal diffusion layer 300 is uniform across the entire layer. In the internal diffusion layer 300, the haze value H may differ depending on a region.

In the display device of Comparative Example 1, it is found that the intensity of sparkles depends on concentration and a degree of uniformity (uniformity) of pigment shaping the design of the decorative member 500 (decorative layer 520). Specifically, the intensity of sparkles occurring in a region where pigment that shapes the design is non-uniformly dispersed is higher than the intensity of sparkles occurring in a region where pigment that shapes the design is uniformly dispersed. In addition, when the degrees of uniformity of pigment shaping the design are approximately the same, the intensity of sparkles occurring in a region with a low concentration of pigment shaping the design is higher than the intensity of sparkles occurring in a region with a high concentration of pigment shaping the design. Therefore, in the display device 10, it is preferable to suppress occurrence of sparkles by making the haze value H in a region in the internal diffusion layer 300 corresponding to a region with a high intensity of sparkles in the decorative member 500 larger than the haze value H in a region in the internal diffusion layer 300 corresponding to a region with a low intensity of sparkles in the decorative member 500.

A display device 10 of the present embodiment includes, as with the display device 10 of Embodiment 1, a liquid crystal display panel 100, an internal diffusion layer 300, a decorative member 500, and a cover 700. In addition, the display device 10 of the present embodiment includes a backlight BL and an adhesive layer 200. Configurations of the liquid crystal display panel 100, the adhesive layer 200, the cover 700, and the backlight BL in the present embodiment are the same as those of Embodiment 1. The internal diffusion layer 300 and the decorative member 500 of the present embodiment are described below.

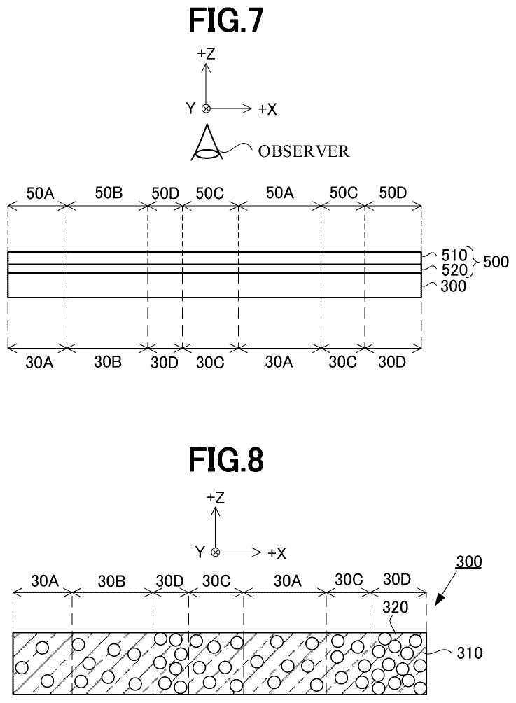

When viewed from an observer side (the +Z side), the decorative member 500 (a main surface 500a on the observer side) of the present embodiment is divided into four types of regions 50A to 50D, as illustrated in FIG. 7. A region 50A is a region where the degree of uniformity of pigment that shapes a design (that is, the decorative layer 520) is high and concentration of the pigment shaping the design is also high. A region 50B is a region where the degree of uniformity of the pigment shaping the design is high and the concentration of the pigment shaping the design is low. A region 50C is a region where the degree of uniformity of the pigment shaping the design is low and the concentration of the pigment shaping the design is high. A region 50D is a region where the degree of uniformity of the pigment shaping the design is low and the concentration of the pigment shaping the design is low.

In other words, magnitudes of optical concentrations of the region 50D, the region 50C, the region 50B, and the region 50A are ranked in ascending order as follows: the region 50D<the region 50C<the region 50B<the region 50A.

When the design is a cross grain pattern colored in dark brown, the wood-grain pattern mainly includes stripes imitating growth rings and numerous stripe-shaped patterns imitating traces of wood vessels, and the region 50A corresponds to a region with fewer stripe-shaped patterns and a lighter color. The region 50B corresponds to a region with fewer stripe-shaped patterns and a darker color. The region 50C corresponds to a region with more stripe-shaped patterns and a lighter color. The region 50D corresponds to a region with more stripe-shaped patterns and a darker color. The other configuration of the decorative member 500 of the present embodiment is the same as the configuration of the decorative member 500 in Embodiment 1.

In a display device not including the internal diffusion layer 300 of the present embodiment (hereinafter, referred to as a display device of Comparative Example 2), based on the above-described relationship between the intensity of sparkles (visibility of sparkles) and the degree of uniformity and concentration of pigment, the intensities of the sparkles are ranked in descending order as follows: the region 50D>the region 50C>the region 50B>the region 50A. Note that a configuration of the display device of the Comparative Example 2 is the same as the configuration of the display device 10 of the present embodiment with the exception of not including the internal diffusion layer 300 of the present embodiment.

The degree of uniformity and concentration of pigment shaping the design can be estimated by, for example, performing image analysis on image data of the design. For example, by applying a Fourier transform on the image data of the design and performing texture analysis on a pattern, the degree of uniformity and concentration of pigment can be estimated. In addition, instead of applying a Fourier transform to the image data of the design, texture analysis may be performed using a grayscale histogram of the image data of the design. Further, the degree of uniformity and concentration of pigment may be estimated from a negative image of the design.

The internal diffusion layer 300 of the present embodiment includes regions 30A to 30D that correspond to the regions 50A to 50D of the decorative member 500, respectively. A region 30A of the internal diffusion layer 300 corresponds to a region 50A of the decorative member 500, and a region 30B of the internal diffusion layer 300 corresponds to a region 50B of the decorative member 500. A region 30C of the internal diffusion layer 300 corresponds to a region 50C of the decorative member 500, and a region 30D of the internal diffusion layer 300 corresponds to a region 50D of the decorative member 500.

The haze values H in the regions 30A to 30D of the internal diffusion layer 300 are set in a descending order as follows: the region 30D>the region 30C>the region 30B>the region 30A in accordance with the descending order of the intensity of sparkles among the regions 50A to 50D of the display device in Comparative Example 2 (that is, the region 50D>the region 50C>the region 50B>the region 50A). The haze values H in the regions 30A to 30D can be adjusted by controlling density of fine particles 320 contained within the regions, as illustrated in FIG. 8. The densities of fine particles 320 in the regions 30A to 30D are ranked in descending order as follows: the region 30D>the region 30C>the region 30B>the region 30A. The other configuration of the internal diffusion layer 300 of the present embodiment is the same as the configuration of the internal diffusion layer 300 in Embodiment 1.

In the present embodiment, the haze values H in the regions 30A to 30D of the internal diffusion layer 300, corresponding to the regions 50A to 50D, differ according to the supposed intensities of sparkles occurring in the regions 50A to 50D of the decorative member 500, that is, according to the concentrations and the degrees of uniformity of pigment shaping designs in the regions 50A to 50D, respectively. A region of the internal diffusion layer 300 with the higher haze value H is arranged correspondingly to a region of the decorative member 500 with the higher supposed intensity of sparkles. Because of this configuration, occurrence of sparkles can be suppressed and at the same time, characters, an image, and the like displayed on the display device 10 can be suppressed from being blurred.

For example, in the display device 10 of the present embodiment in which the decorative member 500 has a design including a wood-grain pattern (a transmittance of 50%, dark brown), setting the haze values H in the regions 30A to 30D of the internal diffusion layer 300 as follows: 20% in the region 30D; 17% in the region 30C; 14% in the region 30B; and 10% in the region 30A enabled occurrence of sparkles to be suppressed and, at the same time, characters, an image, and the like to be suppressed from being blurred.

When the display device 10 includes an internal diffusion layer 300 that has, across the entire layer, a haze value H that enables sparkles in the region 50D of the decorative member 500, where the intensity of sparkles is high, to be suppressed, there is a risk that a display that can be see through the region 50A of the decorative member 500, where the intensity of sparkles is low, becomes blurred due to diffusion of display light by the internal diffusion layer 300. In addition, when the display device 10 includes an internal diffusion layer 300 that has, across the entire layer, a haze value H that enables sparkles in the region 50A of the decorative member 500, where the intensity of sparkles is low, to be suppressed, there is a risk that sparkles in the region 50D of the decorative member 500, where the intensity of sparkles is high, cannot be sufficiently suppressed. In the present embodiment, since depending on supposed intensities of sparkles occurring in the regions 50A to 50D of the decorative member 500, the haze values H in the regions 30A to 30D of the internal diffusion layer 300 are different, sparkles can be suppressed from occurring and at the same time, characters, an image, and the like can be suppressed from being blurred.

### Embodiment 3

In Embodiment 2, the internal diffusion layer 300 includes a single layer. As described below, the internal diffusion layer 300 may include a plurality of layers.

A display device 10 of the present embodiment includes, as with the display device 10 of Embodiment 1, a liquid crystal display panel 100, an adhesive layer 200, an internal diffusion layer 300, a decorative member 500, a cover 700, and a backlight BL. Configurations of the liquid crystal display panel 100, the adhesive layer 200, the cover 700, and the backlight BL in the present embodiment are the same as those of Embodiment 1. In addition, a configuration of the decorative member 500 of the present embodiment is the same as that of Embodiment 2. The internal diffusion layer 300 of the present embodiment is described below.

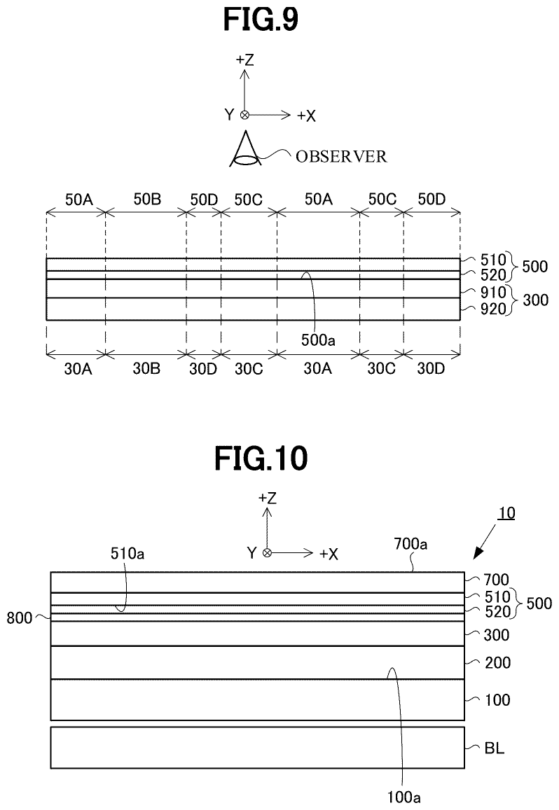

The internal diffusion layer 300 of the present embodiment includes, as illustrated in FIG. 9, a first internal diffusion layer 910 and a second internal diffusion layer 920. The first internal diffusion layer 910 is arranged on the decorative member 500 side and is disposed in direct contact with a main surface 500a of the decorative member 500 (a main surface of a decorative layer 520). The second internal diffusion layer 920 is arranged on the first internal diffusion layer 910.

The first internal diffusion layer 910 includes, as with the internal diffusion layer 300 of Embodiment 2, regions 30A to 30D that correspond to regions 50A to 50D of the decorative member 500, respectively. Haze values H in the regions 30A to 30D of the first internal diffusion layer 910 are, as with the regions 30A to 30D of Embodiment 2, set in a descending order as follows: the region 30D>the region 30C>the region 30B>the region 30A in accordance with a descending order of intensity of sparkles (the region 50D>the region 50C>the region 50B>the region 50A). That is, the haze values H in the regions 30A to 30D of the first internal diffusion layer 910, corresponding to the regions 50A to 50D, respectively, differ according to concentrations and the degrees of uniformity of pigment shaping designs in the regions 50A to 50D. The other configuration of the first internal diffusion layer 910 is the same as the configuration of the internal diffusion layer 300 in Embodiments 1 and 2.

The first internal diffusion layer 910 is made, for example, by printing fine particles 320 at a density set for each of the regions 30A to 30D on a sheet made of binder 310 and curing the binder 310. Alternatively, the first internal diffusion layer 910 may be made by directly printing a mixture containing the binder 310 and the fine particles 320 onto the main surface 500a of the decorative member 500 with respect to each of the regions 30A to 30D and curing the mixtures.

The second internal diffusion layer 920 has a uniform haze value H across the entire layer. A configuration of the second internal diffusion layer 920 is the same as the configuration of the internal diffusion layer 300 of Embodiments 1.

The second internal diffusion layer 920 is made, for example, by shaping a mixture containing the binder 310 and the fine particles 320 into a sheet and curing the mixture.

In the present embodiment, since the internal diffusion layer 300 includes the first internal diffusion layer 910 where the haze values H differ for each of the regions 30A to 30D according to the concentration and the degree of uniformity of pigment that shapes the design of the decorative member 500 and the second internal diffusion layer 920 that has a uniform haze value H across the entire layer, occurrence of sparkles can be more appropriately suppressed and at the same time, characters, an image, and the like can be suppressed from being blurred.

### Variations

Although the embodiments are specifically described above, the present disclosure can be embodied with various modifications without departing from the scope of the present disclosure.

For example, the liquid crystal display panel 100 is not limited to a liquid crystal display panel of an in-plane switching system. The system of the liquid crystal display panel 100 may be a vertical alignment (VA) mode, a twisted nematic (TN) mode, or the like.

In Embodiments 1 and 2, the internal diffusion layer 300 and the decorative member 500 are adhered to each other by the binder 310 in the internal diffusion layer 300. As illustrated in FIG. 10, the internal diffusion layer 300 and the decorative member 500 may be adhered to each other by an adhesive layer (adhesive agent) 800 having translucency. Thickness of the adhesive layer 800 is, for example, 10 μm. Since the internal diffusion layer 300 and the decorative member 500 are adhered to each other by the adhesive layer 800, the internal diffusion layer 300 and the decorative member 500 can be more firmly adhered to each other, and separation of the decorative member 500 can be suppressed.

The thickness D1 of the adhesive layer 200 may be less than 905 μm. In addition, the display device 10 does not have to include the adhesive layer 200, as described later.

The display device 10 does not have to include the cover 700. In addition, the base member 510 of the decorative member 500 may be a glass substrate, a plastic substrate, or the like.

In Embodiment 1, the main surface 700a of the cover 700 is subjected to low reflection treatment. An emitting surface of the display device 10 from which display light emitted from the liquid crystal display panel 100 is emitted is preferably subjected to the low reflection treatment.

The display device 10 may include an organic electro luminescence (EL) display panel or a micro LED display panel in substitution for the liquid crystal display panel 100 and the backlight BL.

The display device 10 may include a plurality of internal diffusion layers 300. For example, the display device 10 may include a layer that has a plurality of light transmitting layers and a plurality of internal diffusion layers 300 and in which the light transmitting layers and the internal diffusion layers 300 are alternately stacked, in place of a single internal diffusion layer 300 in the embodiments. In this case, the amounts of the fine particle 320 contained in the internal diffusion layers 300 may be adjusted in such a way as to gradually increase in a direction from the liquid crystal display panel 100 toward the decorative layer 520 of the decorative member 500 (in the thickness direction). In addition, a sum of thicknesses D2 of the plurality of internal diffusion layers 300 may be 50 μm or more.

The display device 10 may include a plurality of internal diffusion layers 300 with different amounts of fine particle 320 in place of a single internal diffusion layer 300 in Embodiment 1. In this case, the plurality of internal diffusion layers 300 are stacked without a light transmitting layer interposed. In addition, the amounts of the fine particle 320 contained in the internal diffusion layers 300 may be adjusted in such a way as to gradually increase in a direction from the liquid crystal display panel 100 toward the decorative layer 520 of the decorative member 500 (in the thickness direction). The sum of thicknesses D2 of the plurality of internal diffusion layers 300 may be 50 μm or more.

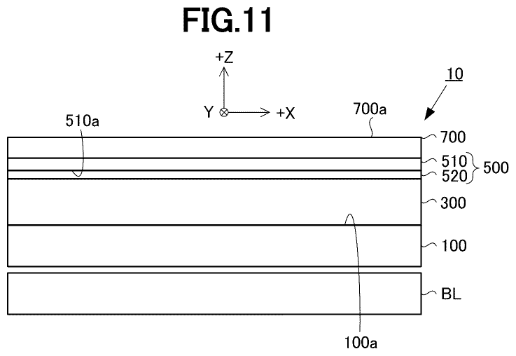

The display device 10 does not have to include the adhesive layer 200, as illustrated in FIG. 11. In this case, the liquid crystal display panel 100 and the internal diffusion layer 300 are adhered to each other by the binder 310 in the internal diffusion layer 300. Since the display device 10 does not include the adhesive layer 200, a manufacturing cost of the display device 10 can be reduced. In addition, it is possible to increase the thickness D2 of the internal diffusion layer 300 and reduce the haze value H of the internal diffusion layer 300. The thickness D2 of the internal diffusion layer 300 in the present variation may be greater than or equal to the sum of the thickness D1 of the adhesive layer 200 and the thickness D2 of the internal diffusion layer 300 in Embodiment 1.

In Embodiment 3, the first internal diffusion layer 910 and the second internal diffusion layer 920 are arranged in an order of the first internal diffusion layer 910 and the second internal diffusion layer 920 from the decorative member 500 side. The first internal diffusion layer 910 and the second internal diffusion layer 920 may be arranged in an order of the second internal diffusion layer 920 and the first internal diffusion layer 910 from the decorative member 500 side.

Preferred embodiments of the present disclosure are described above, but the present disclosure is not limited to such specific embodiments, and, in the present disclosure, the invention described in the appended claims and equivalents thereof are included.

### EXAMPLES

Although the present disclosure is more specifically described below using the following examples, the present disclosure is not limited by the examples.

Hereinbelow, a configuration in which the thickness D1 of the adhesive layer 200, the thickness D2 of the internal diffusion layer 300, the thickness D3 of the decorative layer 520, the perpendicular distance L1 between the display surface 100a of the liquid crystal display panel 100 and the central line C1 in the thickness direction of the decorative layer 520, the perpendicular distance L2 between the central line C2 in the thickness direction of the internal diffusion layer 300 and the central line C1 in the thickness direction of the decorative layer 520, and the perpendicular distance L3 between the display surface 100a of the liquid crystal display panel 100 and the central line C2 in the thickness direction of the internal diffusion layer 300 are set to 895 μm, 50 μm, 30 μm, 960 μm, 40 μm, and 920 μm, respectively is referred to as a configuration A.

In addition, a configuration in which the thickness D1 of the adhesive layer 200, the thickness D2 of the internal diffusion layer 300, the thickness D3 of the decorative layer 520, the perpendicular distance L1 between the display surface 100a of the liquid crystal display panel 100 and the central line C1 in the thickness direction of the decorative layer 520, the perpendicular distance L2 between the central line C2 in the thickness direction of the internal diffusion layer 300 and the central line C1 in the thickness direction of the decorative layer 520, and the perpendicular distance L3 between the display surface 100a of the liquid crystal display panel 100 and the central line C2 in the thickness direction of the internal diffusion layer 300 are set to 495 μm, 450 μm, 30 μm, 960 μm, 240 μm, and 720 μm, respectively is referred to as a configuration B. In the configuration A, the perpendicular distance L2 between the central line C2 in the thickness direction of the internal diffusion layer 300 and the central line C1 in the thickness direction of the decorative layer 520 is shorter (the thickness D2 of the internal diffusion layer 300 is thinner) than in the configuration B.

### Example 1

Using a liquid crystal display panel 100 with a pixel pitch of 129.5 μm, display devices 10 with the configuration A in which the haze value H of the internal diffusion layer 300 is set to 20% and the pattern of the decorative member 500 and the transmittance for display light are varied were produced. Presence or absence of sparkles in the produced display devices 10 was evaluated.

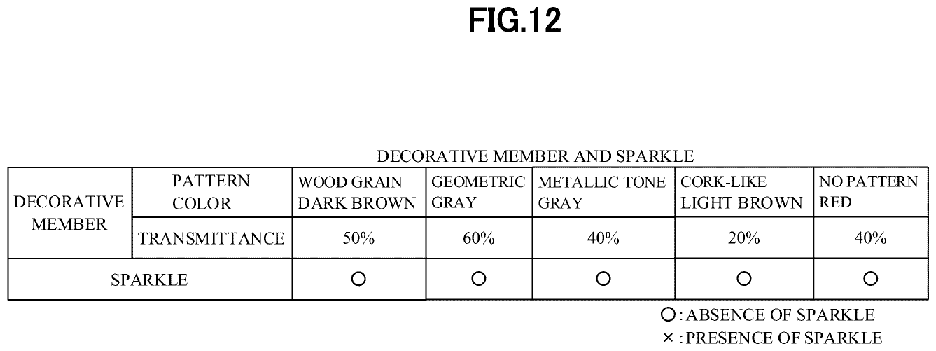

As illustrated in FIG. 12, in the display devices 10 in which the transmittance of the decorative member 500 for display light is greater than or equal to 20%, occurrence of sparkles was able to be suppressed. Note that in display devices not including the internal diffusion layer 300, sparkles were confirmed regardless of the pattern of the decorative member 500 or the transmittance of display light.

### Example 2

Using a liquid crystal display panel 100 with a pixel pitch of 129.5 μm or 180.0 μm and a wood-grain (dark brown, a transmittance of 50%) decorative member 500, display devices 10 with the configuration A in which the haze value H of the internal diffusion layer 300 is varied were produced. In addition, using a liquid crystal display panel 100 with a pixel pitch of 129.5 μm or 180.0 μm and a wood-grain (dark brown, a transmittance of 50%) decorative member 500, display devices 10 with the configuration B in which the haze value H of the internal diffusion layer 300 is varied were produced. Presence or absence of sparkles in the produced display devices 10 was evaluated.

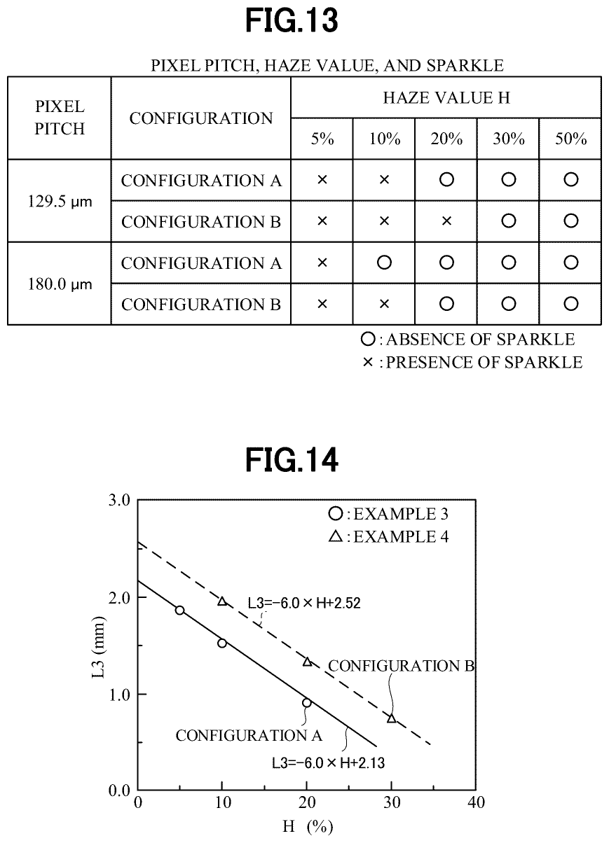

As illustrated in FIG. 13, the configuration A, in which the perpendicular distance L2 between the central line C2 in the thickness direction of the internal diffusion layer 300 and the central line C1 in the thickness direction of the decorative layer 520 is shorter (the thickness D2 of the internal diffusion layer 300 is thinner) than the configuration B, was able to suppress sparkles with a smaller haze value H (L2 of the configuration A is 40 μm and L2 of the configuration B is 240 μm). In addition, even in a display device 10 with the configuration A in which the haze value H of the internal diffusion layer 300 is 10%, occurrence of sparkles was able to be suppressed.

### Example 3

By using a liquid crystal display panel 100 with a pixel pitch of 129.5 μm and a wood-grain (dark brown, a transmittance of 50%) decorative member 500 and changing the thickness D1 of the adhesive layer in the configuration A, a relationship between the haze value H of the internal diffusion layer 300 and the perpendicular distance L3 between the display surface 100a of the liquid crystal display panel 100 and the central line C2 in the thickness direction of the internal diffusion layer 300 that enables occurrence of sparkles to be suppressed was examined (the thickness D2 is 50 μm, the thickness D3 is 30 μm, and the perpendicular distance L2 is 40 μm).

As a result, it was found that when the perpendicular distance L2 between the central line C2 in the thickness direction of the internal diffusion layer 300 and the central line C1 in the thickness direction of the decorative layer 520 is 40 μm, occurrence of sparkles can be suppressed by the perpendicular distance L3 between the display surface 100a of the liquid crystal display panel 100 and the central line C2 in the thickness direction of the internal diffusion layer 300 satisfying the following equation (1) (FIG. 14). In addition, as long as the haze value H of the internal diffusion layer 300 is greater than or equal to 5%, occurrence of sparkles was able to be suppressed.

$$L 3 \geq - 6. \times H + 2 \text{.13} \qquad ( 1 )$$

### Example 4

By using a liquid crystal display panel 100 with a pixel pitch of 129.5 μm and a wood-grain (dark brown, a transmittance of 50%) decorative member 500 and changing the thickness D1 of the adhesive layer in the configuration B, a relationship between the haze value H of the internal diffusion layer 300 and the perpendicular distance L3 between the display surface 100a of the liquid crystal display panel 100 and the central line C2 in the thickness direction of the internal diffusion layer 300 that enables occurrence of sparkles to be suppressed was examined (the thickness D2 is 450 μm, the thickness D3 is 30 μm, and the perpendicular distance L2 is 240 μm).

As a result, it was found that when the perpendicular distance L2 between the central line C2 in the thickness direction of the internal diffusion layer 300 and the central line C1 in the thickness direction of the decorative layer 520 is 240 μm, occurrence of sparkles can be suppressed by the perpendicular distance L3 between the display surface 100a of the liquid crystal display panel 100 and the central line C2 in the thickness direction of the internal diffusion layer 300 satisfying the following equation (2) (FIG. 14).

$$L 3 \geq - 6. \times H + 2.52 \qquad ( 2 )$$

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A display device, comprising:
a display panel;
an internal diffusion layer that is adhered to a display surface of the display panel and diffuses display light emitted from the display panel inside the internal diffusion layer; and
a decorative member that is adhered to the internal diffusion layer, and transmits the display light emitted from the display panel and provides an observer with a design.

2. The display device according to claim 1, wherein the internal diffusion layer includes a binder having translucency and fine particles dispersed in the binder.

3. The display device according to claim 1, wherein according to concentration and a degree of uniformity of pigment shaping the design in each region of the decorative member, a haze value in a region of the internal diffusion layer corresponding to the region of the decorative member differs.

4. The display device according to claim 3, wherein
the internal diffusion layer includes a first internal diffusion layer and a second internal diffusion layer,
in the first internal diffusion layer, according to concentration and a degree of uniformity of pigment shaping the design in each region of the decorative member, a haze value in a region corresponding to the region of the decorative member differs, and
the second internal diffusion layer has a uniform haze value across an entire layer.

5. The display device according to claim 4, wherein the first internal diffusion layer is in direct contact with the decorative member.

6. The display device according to claim 1, wherein thickness of the internal diffusion layer is greater than or equal to 50 μm.

7. The display device according to claim 1, wherein a haze value of the internal diffusion layer is 5% or more and 95% or less.

8. The display device according to claim 1, wherein the decorative member includes a base member having translucency and a decorative layer disposed on the base member.

9. The display device according to claim 1, comprising an adhesive layer that adheres a display surface of the display panel and the internal diffusion layer to each other.

10. The display device according to claim 1, wherein a transmittance of the decorative member for the display light emitted from the display panel is greater than or equal to 20%.

11. The display device according to claim 1, wherein
in a case where a haze value of the internal diffusion layer is denoted by H and perpendicular distance between the display surface of the display panel and a central line in a thickness direction of the internal diffusion layer is denoted by L, the haze value H and the perpendicular distance L satisfy a following equation (1):
$$L \geq - 6. \times H + 2.13 . \qquad ( 1 )$$
